(19) United States
(12) Patent Application Publication
(10) Pub. No.: US 2024/0264818 A1
(43) Pub. Date: Aug. 8, 2024

(54) SYSTEMS AND METHODS FOR SYNCHRONIZING A USER APPLICATION ON A REMOTE DEVICE WITH A SERVER APPLICATION ON A SERVER

(71) Applicant: Honeywell International Inc., Charlotte, NC (US)

(72) Inventors: Dan LI, Beijing (CN); Bin DONG, Beijing (CN); Vladimir KOTALA, Brno (CZ); Jeffrey John van der ZWEEP, Peoria, AZ (US); David M. KOLBET, Scottsdale, AZ (US)

(21) Appl. No.: 18/163,509

(22) Filed: Feb. 2, 2023

(51) Int. Cl. G06F 8/65; G06F 8/71; H04L 67/00; H04L 67/1095

(52) U.S. Cl. CPC G06F 8/65; G06F 8/71; H04L 67/1095; H04L 67/34

(57) ABSTRACT

Disclosed are methods and systems for synchronizing a user application on a remote device with a server application on a server. For instance, a method may include determining, by the remote device, that the user application contains new maintenance information, based on a synchronization table included in the user application, and based on determining that the user application contains the new maintenance information: generating, by the remote device, an update packet including the new maintenance information, sending, by the remote device, the generated update packet to the server, receiving, by the remote device, an indication from the server that the server application has been updated with the generated update packet, and updating, by the remote device, the synchronization table in the user application.

### TECHNICAL FIELD

Various embodiments of the present disclosure relate generally to methods and systems for synchronizing a user application on a remote device with a server application on a server generally.

### BACKGROUND

Fault model and maintenance applications are incredibly important to the aerospace industry, as such technology is essential to ensuring the safety and reliability of aircraft vehicles. Additionally, the ability to save and synchronize maintenance information, regardless of whether there is a connection between the device at the aircraft vehicle and the server system, is important for the safety of the aircraft and the efficiency of the aircraft maintenance. Conventional techniques do not allow for the ability to synchronize the aerospace fault model and maintenance applications when the mobile device is not connected to the main server system. Thus, there exists a need to synchronize fault model and maintenance applications with a main server system, particularly when the devices of such applications are not connected to the main server system.

This disclosure is directed to addressing above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods are disclosed for synchronizing a user application on a remote device with a server application on a server.

In one aspect, an exemplary embodiment of a method for synchronizing a user application on a remote device with a server application on a server is disclosed. The method may include determining, by the remote device, that the user application contains new maintenance information, based on a synchronization table included in the user application. The method may further include, based on determining that the user application contains the new maintenance information: generating, by the remote device, an update packet including the new maintenance information, sending, by the remote device, the generated update packet to the server, receiving, by the remote device, an indication from the server that the server application has been updated with the generated update packet, and updating, by the remote device, the synchronization table in the user application.

In one aspect, a computer system for synchronizing a user application on a remote device with a server application on a server is disclosed. The computer system may include a memory having processor-readable instructions stored therein, and one or more processors configured to access the memory and execute the processor-readable instructions, which when executed by the one or more processors configures the one or more processors to perform a plurality of functions. The functions may include determining, by the remote device, that the user application contains new maintenance information, based on a synchronization table included in the user application. The functions may further include validating the received environment information and the received user information of the assessment data based on additional data received from one or more additional devices other than the one or more devices. The functions may further include, based on determining that the user application contains the new maintenance information: generating, by the remote device, an update packet including the new maintenance information, sending, by the remote device, the generated update packet to the server, receiving, by the remote device, an indication from the server that the server application has been updated with the generated update packet, and updating, by the remote device, the synchronization table in the user application.

In one aspect, a non-transitory computer-readable medium containing instructions for synchronizing a user application on a remote device with a server application on a server is disclosed. The instructions may include determining, by the remote device, that the user application contains new maintenance information, based on a synchronization table included in the user application. The instructions may further include based on determining that the user application contains the new maintenance information: generating, by the remote device, an update packet including the new maintenance information, sending, by the remote device, the generated update packet to the server, receiving, by the remote device, an indication from the server that the server application has been updated with the generated update packet, and updating, by the remote device, the synchronization table in the user application.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a schematic diagram illustrating an exemplary architecture for synchronizing the user application on the remote device, according to one or more embodiments.

FIG. 2 is a flowchart illustrating an exemplary method for a connectivity timer of this disclosure, according to one or more embodiments.

FIG. 3 is a flowchart illustrating a method for synchronizing a task, according to one or more embodiments.

FIG. 4 is a flowchart illustrating a method for providing a remote device with a real-time update, according to one or more embodiments.

FIG. 5 is a flowchart illustrating a process for synchronizing a remote device with a server, according to one or more embodiments.

FIG. 6 is a flowchart illustrating a method for synchronizing a user application on a remote device with a server application on a server, according to one or more embodiments

FIG. 7 depicts a schematic block diagram of a framework of a platform of a connected warehouse system, according to one or more embodiments.

### DETAILED DESCRIPTION OF EMBODIMENTS

According to certain aspects of the disclosure, methods and systems are disclosed for synchronizing a user application on a remote device with a server application on a server. Conventional techniques may not be suitable at least because conventional techniques, among other things, do not allow for the synchronization to occur when the remote device is not connected to the server system. Additionally, conventional techniques may not provide the ability to synchronize the user application software when the remote device is not connected with the server. Accordingly, improvements in technology relating to synchronizing aerospace maintenance user applications on a remote device with a server application on a server are needed.

Fault model and maintenance applications are incredibly important to the aerospace industry, as such technology is essential to ensuring the safety and reliability of aircraft vehicles. There are many different situations where the remote device executing the fault model and maintenance applications is not connected to a main server system. For example, a user may bring the remote device inside of the vehicle while a repair is being made to the vehicle, but the remote device may lose connectivity with the server system. Additionally, the ability to save and synchronize maintenance information, regardless of whether there is a connection between the device at the aircraft vehicle and the server system, is important for the safety of the aircraft and the efficiency of the aircraft maintenance. For example, the improper recordation and storage of maintenance events may result in the vehicle not receiving the maintenance it needs. Thus, there exists a need to synchronize fault model and maintenance applications with a main server system, particularly when the devices of such applications are not connected to the main server system.

Advantages of such a system may include the ability to more efficiently and accurately synchronize the fault model and maintenance applications with the server system. Other advantages may include the ability to keep the applications running efficiently and accurately by ensuring that the software version is always up to date.

The systems and methods disclosed herein relate to synchronizing a user application on a remote device with a server application on a server. The systems and methods may include determining, by the remote device, that the user application contains new maintenance information, based on a synchronization table included in the user application. The systems and methods may further include, based on determining that the user application contains the new maintenance information, generating, by the remote device, an update packet including the new maintenance information. The systems and methods may further include sending, by the remote device, the generated update packet to the server. The systems and methods may further include receiving, by the remote device, an indication from the server that the server application has been updated with the generated update packet. The systems and methods may further include updating, by the remote device, the synchronization table in the user application.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, relative terms, such as, for example, “about,” “substantially,” “generally,” and “approximately” are used to indicate a possible variation of ±10% in a stated value. The term “exemplary” is used in the sense of “example” rather than “ideal.” As used herein, the singular forms “a,” “an,” and “the” include plural reference unless the context dictates otherwise.

### Exemplary Architecture

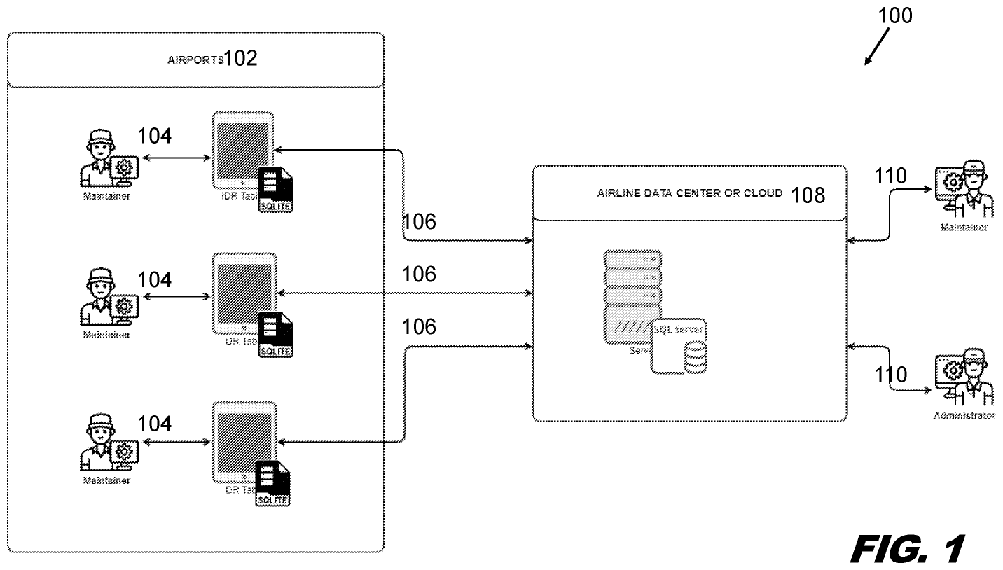

FIG. 1 illustrates an exemplary architecture 100 for synchronizing the user application on the remote device, according to one or more embodiments.

At step 104, one or more users (e.g., aircraft vehicle maintainers) at one or more airports 102 may interact with one or more remote devices (e.g., tablets). The one or more remote devices may include one or more user applications. Example user applications may include aerospace applications for managing vehicle maintenance. For example, the user applications may include fault modeling tools that provide the processes and functions for a user to create, modify, and/or delete fault models and service procedures directed towards aircraft vehicles.

At step 106, the one or more remote devices may communicate with an airline data center or cloud 108. The airline data center or cloud 108 may include one or more servers (e.g., servers or SQL servers). In some embodiments, the one or more servers may include servers that store specific data related to the one or more user applications.

At step 110, maintainers and/or administrators may interact with the airline data center or cloud 108. For example, the maintainers and/or administrators may modify the data and/or data structures within the airline data center or cloud 108 to increase the efficiency of the system.

### Exemplary Method for a Connectivity Timer

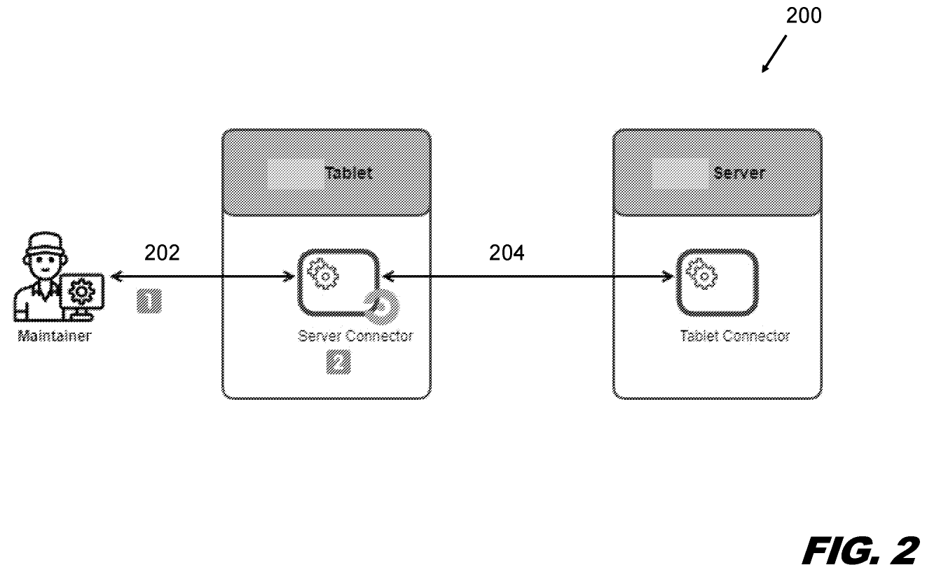

FIG. 2 illustrates an exemplary method 200 for a connectivity timer, according to one or more embodiments.

At step 202, a user (e.g., a vehicle maintainer) may interact with one or more user applications on a remote device (e.g., a tablet). At step 204, a server connector included in the remote device may communicate with one or more servers.

The one or more servers may include one or more tablet connectors. The one or more tablet connectors included in the one or more servers may communicate with the server connector included in the remote device.

For example, the user application executed by the remote device may support an automatic connectivity check. The automatic connectivity check may run in the background of the user application with a corresponding timer. The default status of a task/job may be “off”, where the timer interval may be configured from seconds to minutes. The automatic connectivity check may check the connection between the server connector and the tablet connector. The automatic connectivity check may run in the background with a corresponding timer, where the timer may indicate a frequency of the connectivity check.

### Exemplary Method for Task Synchronization

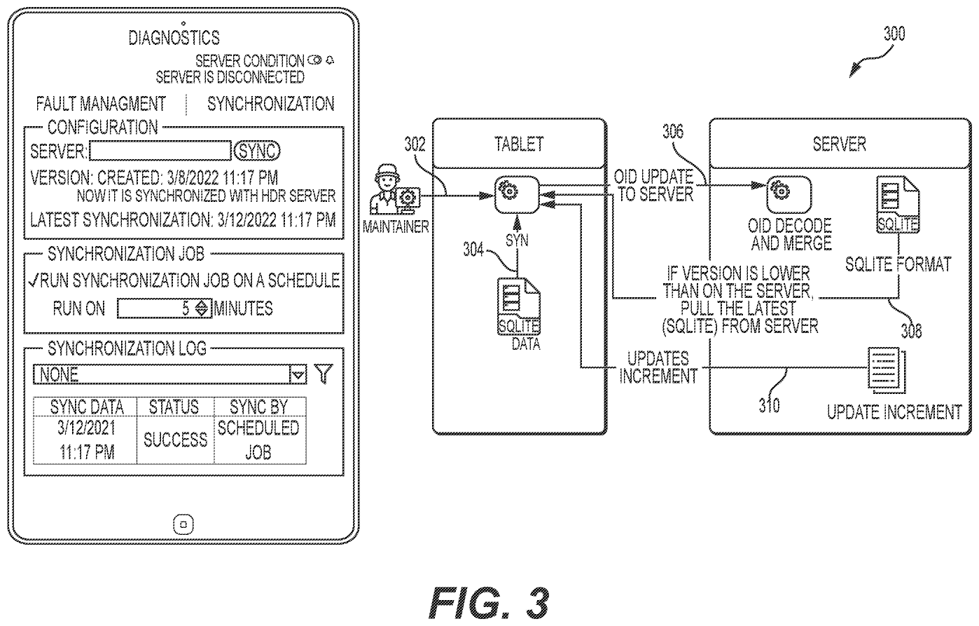

FIG. 3 is a flowchart illustrating a method 300 for synchronizing a task, according to one or more embodiments.

In step 302, the method may include one or more users (e.g., vehicle maintainers) interacting with a user application server on a remote device (e.g., a tablet). The exemplary user interface 312 illustrates a user interface that may be utilized throughout the synchronization process.

In step 304, one or more databases storing data corresponding to the user application may interact with the user application. For example, the one or more databases may receive data from the user application for storage.

In step 306, the tablet may communicate with the server by sending data (e.g., Operational Instance Data (“OID”)) to the server to see if any updates to the user application are needed. The server may decode the OID data and merge such data into a database.

In step 308, if the server determines that the version of the user application is different than the version on the server, the latest version of the user application should be retrieved from the server and sent to the tablet. The server may also check to see if there are any other updates that should be sent to the tablet.

In step 310, the server may update an increment and send such increment to the tablet. The increment may be used to determine which user application version is stored on the tablet. For example, the increment may indicate updates for faults collected from other tablets between synchronizations. Such updates may include fault conditions for new faults or updated faults, assets that may be created or modified, or the like.

Although FIG. 3 shows example blocks of exemplary method 300, in some implementations, the exemplary method 300 may include additional blocks, fewer blocks, different blocks, or differently arranged blocks than those depicted in FIG. 3. Additionally, or alternatively, two or more of the blocks of the exemplary method 300 may be performed in parallel.

### Exemplary Method for a Remote Device Receiving a Real-Time Update

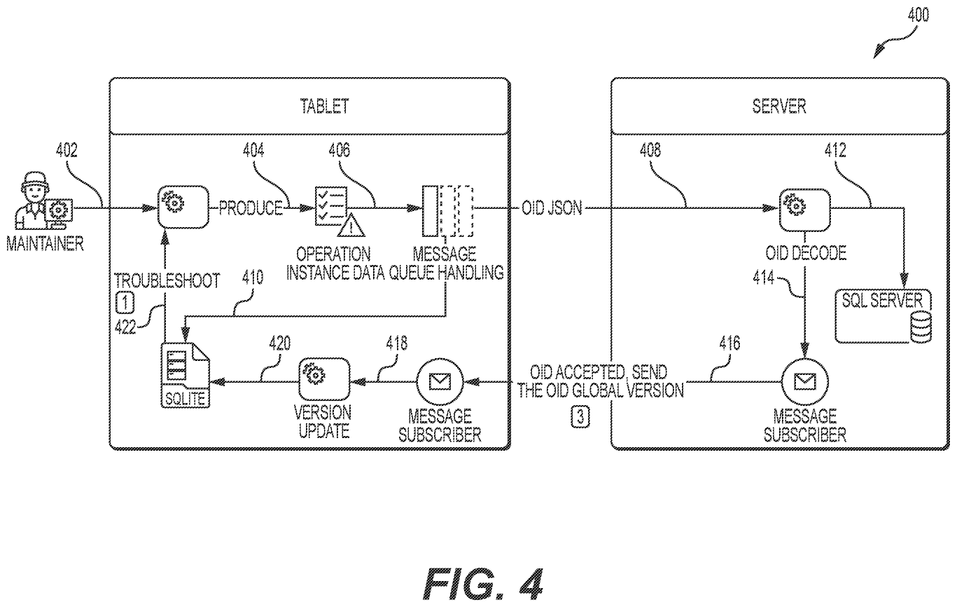

FIG. 4 illustrates an exemplary method 400 for providing a remote device with a real-time update, according to one or more embodiments.

In step 402, a user (e.g., maintainer) may interact with one or more user applications (e.g., aircraft vehicle fault model and maintenance applications) on the tablet.

In step 404, the one or more user applications may produce operation instance data. The operation instance data may be data in a JSON format that may be stored in a system and/or a database. Additionally, the operation instance data may include fault condition information, test results, and the like.

In step 406, the operation instance data may be sent to the message queue handling. The message queue handling may store the operation instance data when the tablet is disconnected from the server. Also, the message queue handling may forward the operation instance data to the server once the tablet is re-connected with the server. The operation instance data may be updated in real-time to the user application when the server connection switch may be off, when the connection between the table and server may work, and/or when the server identifies a new version for the user application on the tablet.

In step 408, the operation instance data may be sent to the server for decoding. In step 412, the decoded operation instance data may be stored in a server (e.g., SQL server).

In step 414, the decoded operation instance data may be sent to a message publisher. For example, when a user (e.g., maintainer) performs troubleshooting on a remote device (e.g., a tablet), a button event may be selected. Upon triggering the button event, a new message may be added to the message queue. A message publisher in the server may process the messages from multiple remote devices (e.g., tablets) and send the updated operation instance data back to the tablet.

In step 416, the message publisher may accept the decoded operation instance data and send the operation instance data global version to a message subscriber of the tablet.

In step 418, the message subscriber may send the operation instance data global version to a version update. In step 420, the version update may be stored in a database (e.g., SQLite). In step 422, the database may communicate with the one or more user applications. In step 410, the message queue handling may send the operation instance data to a database (e.g., SQLite) for storing.

For example, exemplary method 400 may illustrate a real-time update algorithm that may cover an intermittent network scenario. Such an embodiment may provide an advanced synchronization strategy to support different offline scenarios. For example, a JSON string may be applied in the data communication between the tablet and server to reduce a transfer delay. Additionally, the SQLite database and/or SQL server may include one or more tables that are designed to implement the synchronization process.

Although FIG. 4 shows example blocks of exemplary process 400, in some implementations, the exemplary process 400 may include additional blocks, fewer blocks, different blocks, or differently arranged blocks than those depicted in FIG. 4 Additionally, or alternatively, two or more of the blocks of the exemplary process 400 may be performed in parallel.

### Exemplary Process for Synchronizing a Remote Device with a Server

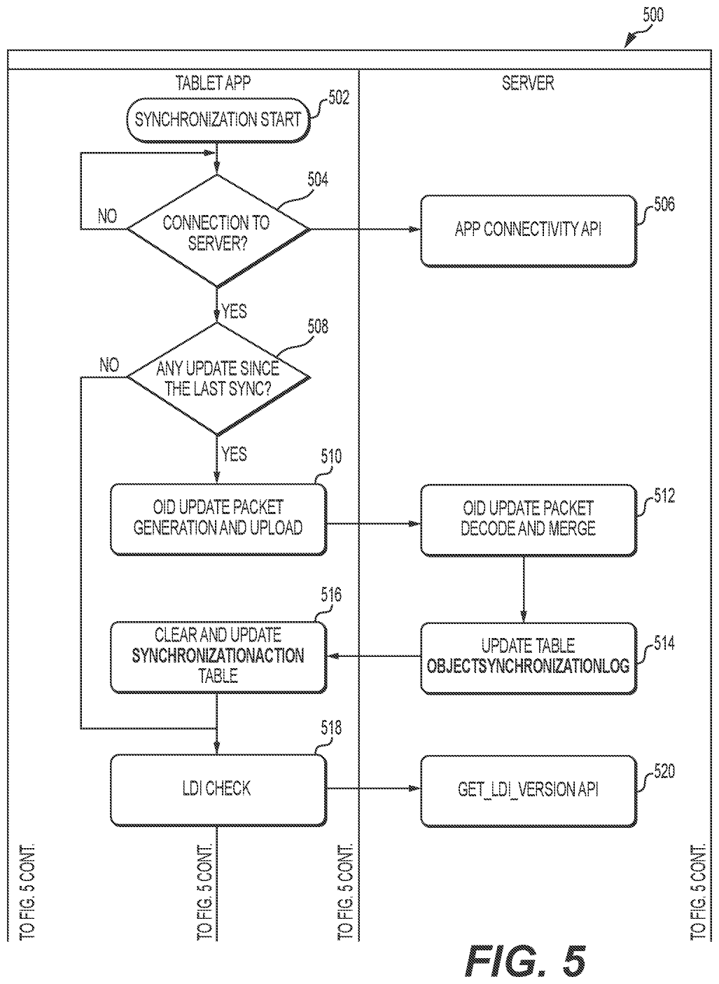

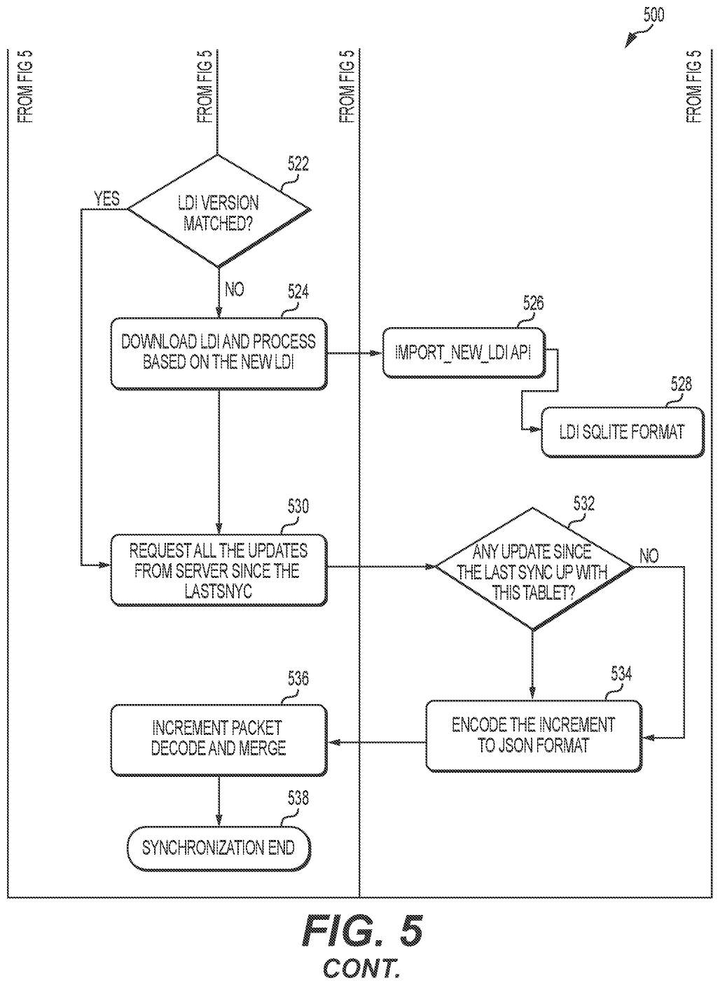

FIG. 5 illustrates an exemplary process 500 for synchronizing a remote device with a server, according to one or more embodiments. Notably, method 500 may be performed by one or more processors of a server that is in communication with one or more user devices and other external system(s) via a network. However, it should be noted that method 500 may be performed by any one or more of the server, one or more user devices, or other external systems. Exemplary method 500 may be executed on one or more components of FIGS. 1-4.

In step 502, the synchronization process may begin. In step 504, the method may include determining whether there is a connection from the remote device (e.g., tablet) to the server. The method may also include determining whether there is a connection by communicating with the server using an application connectivity API (step 506). If there is no connection to the server, the method may repeat step 504.

If there is a connection between the tablet and the server, the method may proceed to step 508, which may include determining whether there have been any software updates to the user application since the last synchronization between the tablet and server. If there has been an update to the user application since the last synchronization, the method may proceed to step 510, where an operation instance data update packet may be generated and uploaded to the server. If there has not been an update since the last synchronization, the method may proceed to step 520.

In step 512, the server may receive the operation instance data update packet, decode the packet, and merge the packet. For example, some or all of the packet may be in a format that may need to be decoded in order to be accessed. For example, the operation instance data update packet may be in a JSON format, which may need to be decoded into a JSON object on the server side, and then merged into a current data package. In step 514, the method may include updating a synchronization table based on the decoded operation instance data update packet. The synchronization table may be used to store a synchronization package. Additionally an operation related to a fault may trigger updated or new data to be added (e.g., a troubleshooting step selection, updating a test result, and/or closing a fault).

In step 516, the method may include clearing and updating a synchronization action table stored in the tablet. The tablet may store a synchronization action table in a database (e.g., SQLite database). The synchronization action table may log the changes and the actions in the tablet between synchronizations with the server. For example, if the tablet is disconnected from the server, but there have been changes and actions made to the user application, the synchronization action table may store such changes and actions. Once the tablet is connected to the server, the changes and actions stored in the synchronization action table may be communicated to the server. Additionally, the tablet may generate a table for operational instance data and synchronization packets that is based on the synchronization action table and/or one or more other associated tables. The table may also store a date and time corresponding to the last synchronization with the server.

In step 518, the method may include checking the version of the user application stored in the tablet. For example, the version of the application may be checked by communicating with the server using an API to get the current version (step 520).

In step 522, the method may include determining whether the version of the user application matches the version stored in the server. If the version does not match the version in the server, the method may proceed to step 524. If the version does match the version in the server, the method may proceed to step 530.

For example, if the versions do not match, the tablet may download the latest SQLite format version from the server. During the synchronization process, the table might change some fault statuses (e.g., delete the fault status and/or delete such fault status).

In step 524, the method may include the tablet downloading the version and processing the version based on the new version. The downloading may include communicating with the server via one or more APIs (e.g., IMPORT_NEW_LDI_API) (Step 526). The method may also include retrieving a SQLite format from one or more databases.

In step 530, the method may include requesting all the updates from the server since the last synchronization. The requesting may include communicating with the server to determine if there have been any updates since the last synchronization with the tablet (step 532). For example, the tablet may send a unique identifier (e.g., UUID) to the server when requesting a synchronization with the server. In some embodiments, the tablet may also send the date and time of the last synchronization with the server.

If there have been updates since the last synchronization with the tablet, the method may include encoding the increment to a JSON format (Step 534). For example, in response to receiving the synchronization request, the server may send an increment to the tablet. The increment may include one or more updated objects, which may synchronize the tablet with the server. If there have not been any updates since the last synchronization with the tablet, the method may proceed to step 536.

In step 536, the method may include incrementing the packet, decoding the packet, and merging the packet. For example, upon decoding the packet, the updates in the packet may be applied to the one or more user applications.

In step 538, the method may include the synchronization process ending.

Although FIG. 5 shows example blocks of exemplary method 500, in some implementations, the exemplary method 500 may include additional blocks, fewer blocks, different blocks, or differently arranged blocks than those depicted in FIG. 5. Additionally, or alternatively, two or more of the blocks of the exemplary method 500 may be performed in parallel.

### Exemplary Method for Synchronizing a User Application with a Server Application

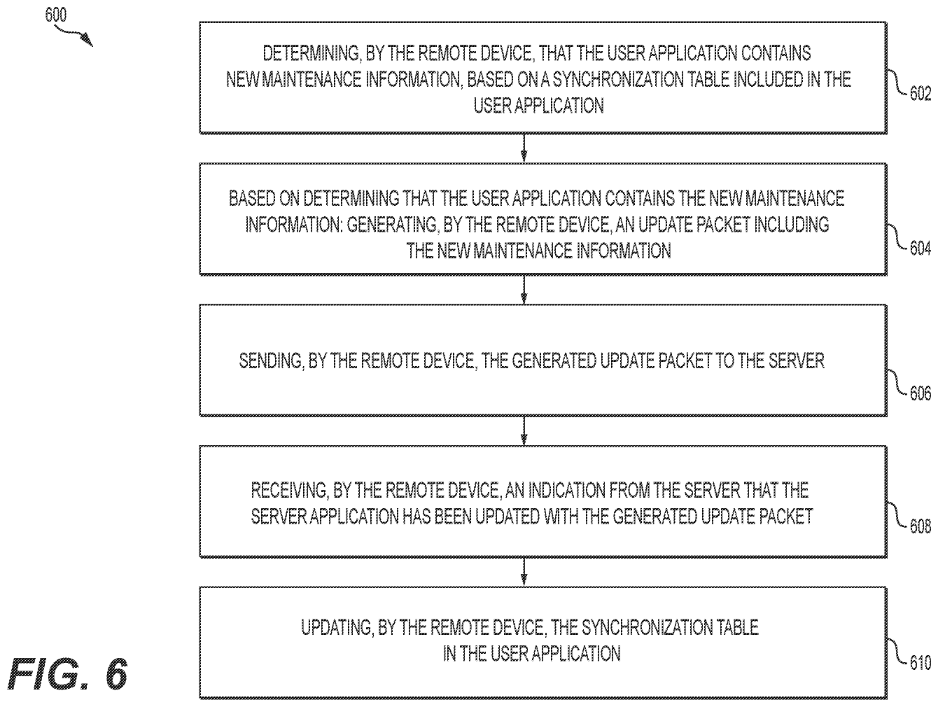

FIG. 6 illustrates an exemplary method 600 for synchronizing a user application on a remote device with a server application on a server, according to one or more embodiments. Notably, method 600 may be performed by one or more processors of a server that is in communication with one or more user devices and other external system(s) via a network. However, it should be noted that method 600 may be performed by any one or more of the server, one or more user devices, or other external systems. Exemplary method 600 may be executed on one or more components of FIGS. 1-5.

The method may include determining, by the remote device, that the user application contains new maintenance information, based on a synchronization table included in the user application (Step 602). For example, the user application may include an aerospace application for managing vehicle maintenance. The synchronization table may store one or more changes to the new maintenance information and one or more actions corresponding to the new maintenance information. Additionally, the synchronization table may store one or more changes and/or one or more actions that occurred since a last synchronization with a server. The maintenance information may include new maintenance requests, comments/outcomes of maintenance requests, maintenance service performed on a corresponding vehicle, and the like.

The method may include, based on determining that the user application contains the new maintenance information: generating, by the remote device, an update packet including the new maintenance information (Step 604). For example, the update packet may include the one or more changes and/or the one or more actions corresponding to the vehicle. The update packet may also include a unique identifier associated with the remote device. Additionally, determining that the user application contains new maintenance information may include analyzing the synchronization table for data. If the synchronization table includes data that may indicate that the changes and/or actions occurred since the last synchronization. If the synchronization table does not include data that may indicate that there are no changes and/or actions that occurred since the last synchronization.

The method may include sending, by the remote device, the generated update packet to the server (Step 606). The remote device may send the generated update packet to the server to indicate that actions and/or changes occurred to the maintenance information while the tablet was not connected to the server.

The method may include receiving, by the remote device, an indication from the server that the server application has been updated with the generated update packet (Step 608). For example, upon receiving the generated update packet, the server may update a synchronization table stored in the server. Additionally, for example, the server may update one or more databases to synchronize such databases with the data of the generated update packet. Once the server has updated its system with the generated update packet data, the server may create and/or update an indication that the server application has been updated with the generated update packet. The server may then send such indication to the remote device.

The method may include updating, by the remote device, the synchronization table in the user application (Step 610). Upon receiving the indication, the remote device may update the corresponding synchronization table in the user application with the data of the indication. The indication may include an update date and time for each update. The remote device may store the date and time of the last synchronization locally. Additionally, for example, if the update date and time for each update is later than the synchronization date and time, the update may be effective for the tablet.

In some embodiments, the method may include receiving, by the remote device, version control information from the server. The version control information may include a version number, a unique identifier corresponding to the remote device, a date of the last update, a time of the last update, and the like. The method may further include determining, by the remote device, that a version of the user application should be updated, based on the received version control information. The server may analyze the version control information and compare such version control information to information stored in the server. Upon comparing the information, the server may determine that an updated version is available and the user application on the remote device should be updated. The method may further include, based on determining that the version of the user application should be updated, receiving, by the remote device, a software update for the user application from the server application. The server may identify the software update that corresponds to a newer version than the version stored on the remote device. Additionally, the server may then send such newer version to the remote device. The method may further include updating, by the remote device, the user application with the received software update for the user application. Upon receiving the software update, the user application may apply such software update to the user application.

In some embodiments, the method may include receiving, by the remote device from the server, related maintenance information from a different user application on a different remote device. The method may further include updating, by the remote device, the user application with the received related maintenance information. For example, the related maintenance information may correspond to maintenance that was administered to the same vehicle, but the different remote device may not have been connected to the server. Additionally, upon the different remote device connecting and synchronizing with the server, the server may determine that the remote device has not been updated with the related maintenance information. As a result, the server may send the related maintenance information to the remote device to ensure that the remote device is synchronized with the server.

In some embodiments, the method may include determining that the synchronization table was not updated with scheduled maintenance. For example, the method may include analyzing scheduling maintenance data corresponding to the vehicle. The method may further include determining that a time threshold from the scheduled maintenance occurred. For example, analyzing the scheduling maintenance data may include analyzing one or more corresponding time thresholds. The one or more corresponding time thresholds (e.g., date and/or time stamp) may indicate when the scheduled maintenance should occur. The time thresholds may indicate that one or more scheduled maintenance events should have occurred, but the remote device does not include data corresponding to the one or more scheduled maintenance events. The method may further include displaying a non-synchronization notification indicating that the synchronization table should be updated. The non-synchronization notification may be displayed on the remote device and/or the server. Additionally, in response to receiving the non-synchronization notification, the server may send the remote device updated maintenance data corresponding to the scheduled maintenance. Upon receiving the updated maintenance data, the remote device may update the user application and/or one or more data stores.

Although FIG. 6 shows example blocks of exemplary method 600, in some implementations, the exemplary method 600 may include additional blocks, fewer blocks, different blocks, or differently arranged blocks than those depicted in FIG. 6. Additionally, or alternatively, two or more of the blocks of the exemplary method 600 may be performed in parallel.

### Exemplary Device

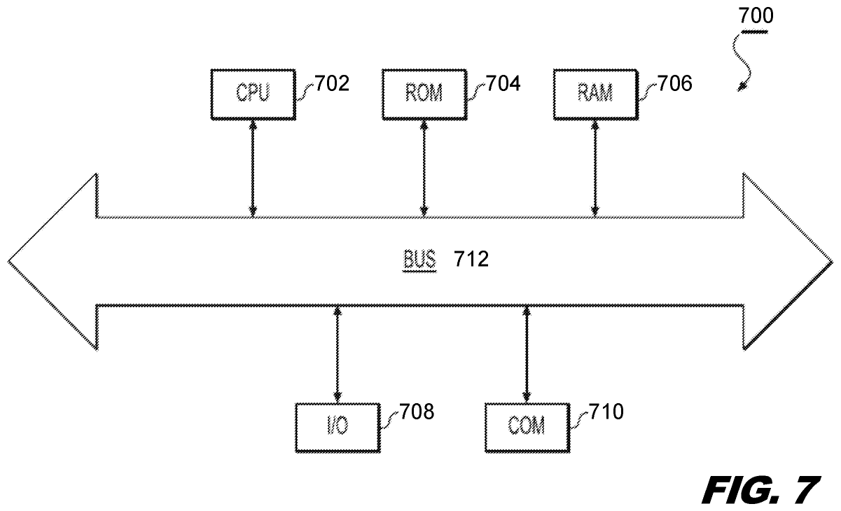

FIG. 7 is a simplified functional block diagram of a computer 700 that may be configured as a device for executing the methods of FIGS. 1-6, according to exemplary embodiments of the present disclosure. For example, device 700 may include a central processing unit (CPU) 720. CPU 720 may be any type of processor device including, for example, any type of special purpose or a general-purpose microprocessor device. As will be appreciated by persons skilled in the relevant art, CPU 720 also may be a single processor in a multi-core/multiprocessor system, such system operating alone, or in a cluster of computing devices operating in a cluster or server farm. CPU 720 may be connected to a data communication infrastructure 710, for example, a bus, message queue, network, or multi-core message-passing scheme.

Device 700 also may include a main memory 740, for example, random access memory (RAM), and also may include a secondary memory 730. Secondary memory 730, e.g., a read-only memory (ROM), may be, for example, a hard disk drive or a removable storage drive. Such a removable storage drive may comprise, for example, a floppy disk drive, a magnetic tape drive, an optical disk drive, a flash memory, or the like. The removable storage drive in this example reads from and/or writes to a removable storage unit in a well-known manner. The removable storage unit may comprise a floppy disk, magnetic tape, optical disk, etc., which is read by and written to by the removable storage drive. As will be appreciated by persons skilled in the relevant art, such a removable storage unit generally includes a computer usable storage medium having stored therein computer software and/or data.

In alternative implementations, secondary memory 730 may include other similar means for allowing computer programs or other instructions to be loaded into device 700. Examples of such means may include a program cartridge and cartridge interface (such as that found in video game devices), a removable memory chip (such as an EPROM, or PROM) and associated socket, and other removable storage units and interfaces, which allow software and data to be transferred from a removable storage unit to device 700.

Device 700 also may include a communications interface (“COM”) 760. Communications interface 760 allows software and data to be transferred between device 700 and external devices. Communications interface 760 may include a modem, a network interface (such as an Ethernet card), a communications port, a PCMCIA slot and card, or the like. Software and data transferred via communications interface 760 may be in the form of signals, which may be electronic, electromagnetic, optical, or other signals capable of being received by communications interface 760. These signals may be provided to communications interface 760 via a communications path of device 700, which may be implemented using, for example, wire or cable, fiber optics, a phone line, a cellular phone link, an RF link or other communications channels.

The hardware elements, operating systems and programming languages of such equipment are conventional in nature, and it is presumed that those skilled in the art are adequately familiar therewith. Device 700 also may include input and output ports 750 to connect with input and output devices such as keyboards, mice, touchscreens, monitors, displays, etc. Of course, the various server functions may be implemented in a distributed fashion on a number of similar platforms, to distribute the processing load. Alternatively, the servers may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Reference to any particular activity is provided in this disclosure only for convenience and not intended to limit the disclosure. A person of ordinary skill in the art would recognize that the concepts underlying the disclosed devices and methods may be utilized in any suitable activity. The disclosure may be understood with reference to the following description and the appended drawings, wherein like elements are referred to with the same reference numerals.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for synchronizing a user application on a remote device with a server application on a server, the method comprising:
determining, by the remote device, that the user application contains new maintenance information, based on a synchronization table included in the user application; and
based on determining that the user application contains the new maintenance information:
generating, by the remote device, an update packet including the new maintenance information;
sending, by the remote device, the generated update packet to the server;
receiving, by the remote device, an indication from the server that the server application has been updated with the generated update packet; and
updating, by the remote device, the synchronization table in the user application.

2. The computer-implemented method of claim 1, the method further comprising:
receiving, by the remote device, version control information from the server; and
determining, by the remote device, that a version of the user application should be updated, based on the received version control information.

3. The computer-implemented method of claim 2, the method further comprising:
based on determining that the version of the user application should be updated, receiving, by the remote device, a software update for the user application from the server application; and
updating, by the remote device, the user application with the received software update for the user application.

4. The computer-implemented method of claim 1, the method further comprising:
receiving, by the remote device from the server, related maintenance information from a different user application on a different remote device; and
updating, by the remote device, the user application with the received related maintenance information.

5. The computer-implemented method of claim 1, wherein the user application includes an aerospace application for managing vehicle maintenance.

6. The computer-implemented method of claim 1, the method further comprising:
determining that the synchronization table was not updated with scheduled maintenance;
determining that a time threshold from the scheduled maintenance occurred; and
displaying a non-synchronization notification indicating that the synchronization table should be updated.

7. The computer-implemented method of claim 1, wherein the synchronization table stores one or more changes to the new maintenance information and one or more actions corresponding to the new maintenance information.

8. A computer system for synchronizing a user application on a remote device with a server application on a server, the computer system comprising:
a memory having processor-readable instructions stored therein; and
one or more processors configured to access the memory and execute the processor-readable instructions, which when executed by the one or more processors configures the one or more processors to perform a plurality of functions, including functions for:
determining, by the remote device, that the user application contains new maintenance information, based on a synchronization table included in the user application; and
based on determining that the user application contains the new maintenance information:
generating, by the remote device, an update packet including the new maintenance information;
sending, by the remote device, the generated update packet to the server;
receiving, by the remote device, an indication from the server that the server application has been updated with the generated update packet; and
updating, by the remote device, the synchronization table in the user application.

9. The computer system of claim 8, the functions further comprising:
receiving, by the remote device, version control information from the server; and
determining, by the remote device, that a version of the user application should be updated, based on the received version control information.

10. The computer system of claim 9, the functions further comprising:
based on determining that the version of the user application should be updated, receiving, by the remote device, a software update for the user application from the server application; and
updating, by the remote device, the user application with the received software update for the user application.

11. The computer system of claim 8, the functions further comprising:
receiving, by the remote device from the server, related maintenance information from a different user application on a different remote device; and
updating, by the remote device, the user application with the received related maintenance information.

12. The computer system of claim 8, wherein the user application includes an aerospace application for managing vehicle maintenance.

13. The computer system of claim 8, the functions further comprising:
determining that the synchronization table was not updated with scheduled maintenance;
determining that a time threshold from the scheduled maintenance occurred; and
displaying a non-synchronization notification indicating that the synchronization table should be updated.

14. The computer system of claim 8, wherein the synchronization table stores one or more changes to the new maintenance information and one or more actions corresponding to the new maintenance information.

15. A non-transitory computer-readable medium containing instructions for synchronizing a user application on a remote device with a server application on a server, the instructions comprising:
determining, by the remote device, that the user application contains new maintenance information, based on a synchronization table included in the user application; and
based on determining that the user application contains the new maintenance information:
generating, by the remote device, an update packet including the new maintenance information;
sending, by the remote device, the generated update packet to the server;
receiving, by the remote device, an indication from the server that the server application has been updated with the generated update packet; and
updating, by the remote device, the synchronization table in the user application.

16. The non-transitory computer-readable medium of claim 15, the instructions further comprising:
receiving, by the remote device, version control information from the server; and
determining, by the remote device, that a version of the user application should be updated, based on the received version control information.

17. The non-transitory computer-readable medium of claim 16, the instructions further comprising:
based on determining that the version of the user application should be updated, receiving, by the remote device, a software update for the user application from the server application; and
updating, by the remote device, the user application with the received software update for the user application.

18. The non-transitory computer-readable medium of claim 15, the instructions further comprising:
receiving, by the remote device from the server, related maintenance information from a different user application on a different remote device; and
updating, by the remote device, the user application with the received related maintenance information.

19. The non-transitory computer-readable medium of claim 15, wherein the user application includes an aerospace application for managing vehicle maintenance.

20. The non-transitory computer-readable medium of claim 15, the instructions further comprising:
determining that the synchronization table was not updated with scheduled maintenance;
determining that a time threshold from the scheduled maintenance occurred; and
displaying a non-synchronization notification indicating that the synchronization table should be updated.
